(19) United States
(12) Patent Application Publication
(10) Pub. No.: US 2004/0041007 A1
(43) Pub. Date: Mar. 4, 2004

(54) Method of producing clamping rings

(76) Inventor: Rolf Cremerius, St. Augustin (DE)

Correspondence Address: Robert P. Renke, Suite 250, 28333 Telegraph Road, Southfield, MI, 48034, US

(21) Appl. No.: 10/613,242

(22) Filed: Jul. 3, 2003

(30) Foreign Application Priority Data
Jul. 6, 2002 (DE) 102 30 493.9

(51) Int. Cl. B23P 11/00; B21D 39/00; B23K 31/02

(52) U.S. Cl. 228/173.6; 29/509

(57) ABSTRACT

A method of producing metal clamping rings which serve to secure elastic sleeves on components which are movable relative to one another, such as, for securing convoluted boots on joints and intermediate shafts of motor vehicle driveshafts. The method includes producing a strip portion from plate metal, which strip portion comprises strip ends which match and complement one another and which are delimited so as to be undercut-free in the longitudinal direction; bending the strip portion so as to render same round and fixing same so as to form a cylindrical ring with abutting strip ends; and welding the strip ends so that they form a clamping ring.

### TECHNICAL FIELD

The invention relates to a method producing metal clamping rings which serve to secure sleeves made of an elastic material on components which are movable relative to one another, more particularly, for securing convoluted boots on joints and intermediate shafts of motor vehicle driveshafts. The invention also relates to a method of securing sleeves made of an elastic material on cylindrical metallic components, such as, for securing convoluted boots on joints and intermediate shafts of motor vehicle driveshafts, by means of clamping rings made of metal.

### BACKGROUND OF THE INVENTION

For securing elastic sleeves on metal components, there are known different types of binding elements comprising overlapping ends which can be displaced relative to one another in the circumferential direction and which comprise form-fitting engaging means which can be fixed relative to one another, thus enabling a sleeve to be secured to one of the components due to the resulting narrowing of the binding elements. The design of the inter-engaging engaging means at the strip ends greatly increases the production costs. Furthermore, there are known binding elements consisting of a planar plate metal strip portion whose strip ends, by means of projections and recesses, while being positioned form-fittingly in one plane, fittingly inter-engage one another, wherein the projections and recesses are caulked, squeezed or point-welded relative to one another. In this way, there is formed a closed annular member which initially comprises an excess dimension or a clearance fit relative to the elastic sleeve and is radially upset for the purpose of being secured to one of the components. This type of upsetting is generally referred to as “crimping.” Binding elements of this type, when used permanently, can fail at the join. Two examples of such binding elements are disclosed in U.S. Pat. Nos. 5,001,816 and 5,150,503.

### SUMMARY OF THE INVENTION

The present invention provides a method of producing metal clamping rings for securing elastic sleeves on components which are moveable with respect to each other. The invention also provides a method of securing elastic sleeves, by means of which method it is possible to offer qualitatively improved clamping rings and connections with an improved durability.

In one embodiment, the method of producing metal clamping rings includes producing a strip portion from plate metal, which strip portion comprises strip ends which match and complement one another and which are delimited so as to be undercut-free in the longitudinal direction; bending the strip portion so as to render same round and fixing same so as to form a cylindrical ring with abutting strip ends; and welding the strip ends so that they form a clamping ring.

In another aspect, the invention relates to a method of fixing sleeves made of an elastic material on cylindrical components which are moveable with respect to each other. The method includes producing a strip portion from plate metal, which strip portion comprises strip ends which match and complement one another and which are delimited so as to be undercut-free in the longitudinal direction; bending the strip portion so as to render same round and fixing same so as to form a cylindrical ring with abutting strip ends; welding the strip ends so that they form a clamping ring; slipping the clamping ring on to a sleeve which is made of an elastic material and is positioned on one of the components; and radially upsetting the clamping ring, with the clamping ring being permanently plastically deformed and with the sleeve being permanently elastically deformed. The last step can be considered a crimping operation.

Cutting strip into lengths to form strip portions from a coil is inexpensive and does not require any special form-fittingly engaging strip ends. In the present case, “undercut-free in the longitudinal direction” means that it is possible to see the entire edge extension of the strip ends when viewing the strip ends in the longitudinal direction of the strip portion. In this way it becomes possible for the strip ends to abut one another in the plane of the strip portion after it has been bent so as to be round. After the strip portions have been bent into the round condition and fixed, for which operation suitable devices are available on the market, it is possible to connect the strip ends by simple butt welding.

In one embodiment, use is made of laser welding, plasma welding or electron beam welding without weakening the material in the region of the welds, more particularly, without introducing an excessive amount of heat. A loss in the strength of the material in the region adjoining the weld should be avoided. It is also desirable to ensure that the weld does not increase the strip thickness in the welding region, so that there is no need for subsequently machining the welded region. The strip ends can be cut to have straight ends at a right angle relative to the longitudinal direction. Such an operation should be given preference as it minimizes manufacturing costs. From the point of view of strength, an inclined extension of the butt of the two strip ends or bevelled butt edge with otherwise straight strip ends and straight edges can be more advantageous. The result is a closed tensioning ring of uniform strength. Primarily for visual reasons, for a qualitatively higher-value result, the strip ends can be welded together continuously. For strength considerations alone, it is sufficient for the strip ends to be welded together point-like or in portions because the forces applied by an elastically deformed sleeve to the clamping ring do not approach the strength limit of the clamping ring.

For securing elastic sleeves in accordance with an inventive clamping ring, the clamping ring is slid on to the sleeve with play or without pre-tension. Depending on the assembly conditions, this can be affected after the sleeve, in turn, has been slid on to one of the components. Alternatively, the clamping ring can be positioned before the sleeve has been slid on to one of the components. Subsequently, the clamping ring is upset radially, reaching the range of plastic deformation and, in the process, elastically deforming the sleeve in the radial direction. Depending on the material of the sleeve, the degree of plastic deformation can be very low. In particular, if the inside of the sleeve form-fittingly engages a groove in the component, there is no need for the sleeve to be subjected to a high degree of radial pretension in order to prevent the sleeve from being removed from the component. For unfastening the connection between the sleeve and the component, the clamping ring necessarily has to be destroyed. In the region of their connection, the component, the sleeve and the clamping ring normally comprise a circular cross-section having a cylindrical shape.

Radial deformation can be effected by crimping, using an annular tool which is circumferentially divided in several segments and which comprises individual, radially inwardly adjustable segments. However, it is also possible to carry out radial upsetting by electromagnetic forces applied by an annularly arranged electric coil assembly to the clamping ring. It is advantageous for the welded clamping ring to be a fully electrically conducting annular member.

As far as the material of the clamping ring is concerned, VA steel or aluminum alloys are particularly suitable. Prior to the strip material being cut to lengths, the edges of the strip material can be subjected to round rolling, which prevents the sleeve from being damaged.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

Several illustrations in connection with the present invention are shown in the drawings:

FIG. 1 shows a coil of the starting material suitable for use in the present method.

FIG. 2 shows a finished clamping ring in accordance with one embodiment of the invention.

FIGS. 3A and 3B show one embodiment for the butt joint of an inventive clamping ring in a top view and end view, respectively.

FIGS. 4A and 4B show another embodiment for the butt joint of an inventive clamping ring in a top view and end view, respectively.

FIG. 5, in an axial view, illustrates the principle of the design of a device for mechanical crimping, using an inventive clamping ring.

FIG. 6, in a longitudinal section, illustrates the principle of the design of a device for electromagnetic crimping, using an inventive clamping ring.

FIG. 7, in a side view, shows part of a driveshaft with two inventive clamping rings.

### DETAILED DESCRIPTION OF THE INVENTION

In the following description, various components and features are described for several embodiments. These specific features and components are included as examples and are not meant to be limiting.

FIG. 1 shows a coil of strip material 12. The strip end 13 has been cut off at a right angle relative to the longitudinal direction of the strip material 12.

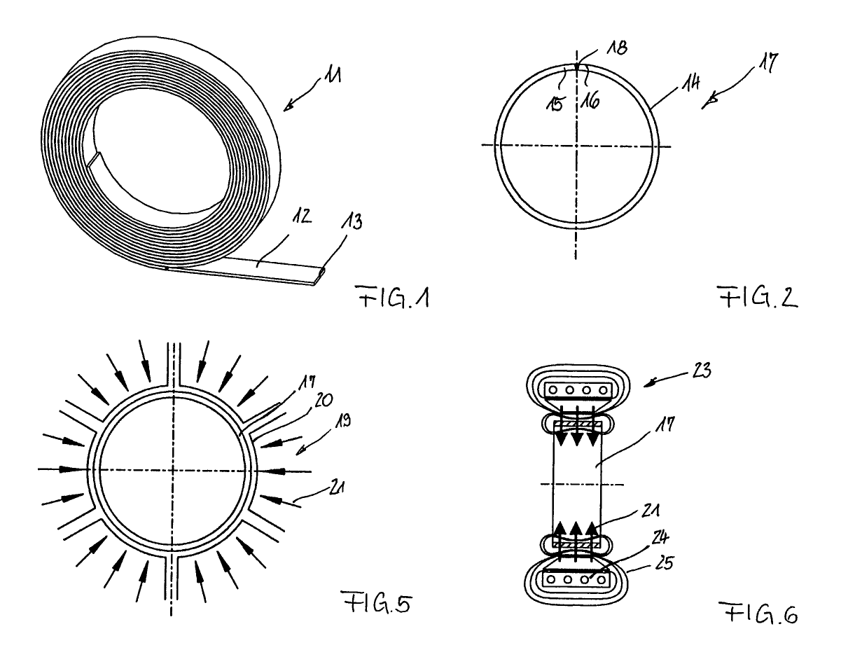

FIG. 2, at its bottom end, shows a side view of a strip portion 14 bent so as to be round, with strip ends cut off at a right angle, with the strip ends having been given the reference numbers 15 and 16. The strip portion 14 is used to produce an inventive clamping ring 17 in that the strip portion 14, by means of a butt weld 18, is closed to form a ring. For purposes of joining butt ends of strip material to form a clamping ring, the strip ends can be cut in several forms.

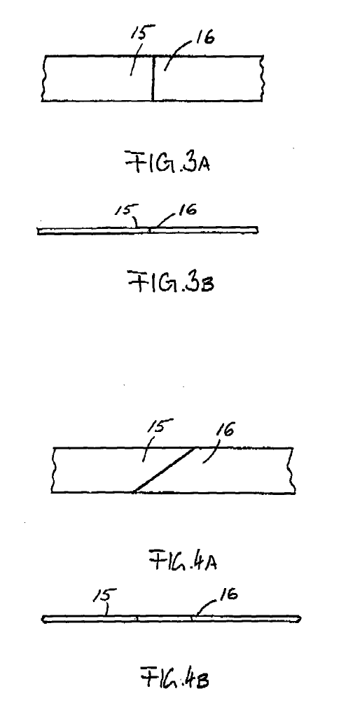

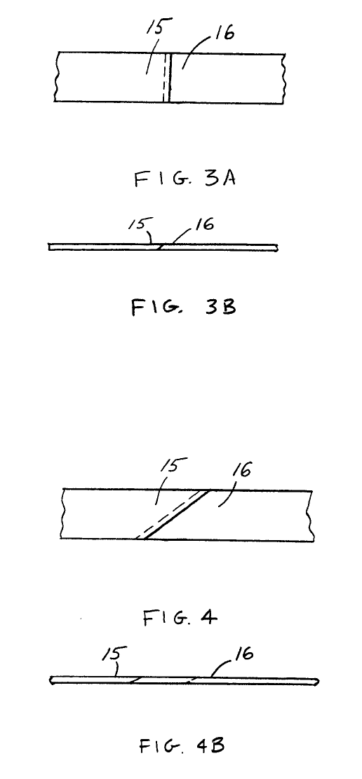

Referring now to FIGS. 3A and 3B, there is shown one arrangement for the butt joint of an inventive clamping ring. In FIGS. 3A and 3B, the strip ends 15, 16 are beveled, but otherwise straight and perpendicular to the longitudinal direction of the strip material. The strip ends 15, 16 can also be cut at an angle with respect to the longitudinal direction of the strip material. Combined angled and beveled strip ends 15, 16 can also be employed for the butt joint of an inventive clamping ring as shown in the top and end views of FIG. 4A and 4B, respectively. Moreover, these butt joints can be welded together by a continuous weld, or a point or stitch weld pattern. Suitable welding methods include laser, plasma or electron beam welding.

FIG. 5 shows an inventive clamping ring 17 and an annular crimping device 19 which has six segments 20 and which is able radially to upset the clamping ring 17 by simultaneously radially feeding in the segments 20. The direction of travel is indicated by arrows 21. The clamping ring 17 is positioned around the sleeve and the component to which the sleeve has to be secured (not illustrated).

FIG. 6 shows an inventive clamping ring 17 and an electromagnetic clamping device 23 having a circular, concentrically arranged magnetic coil 24 which is able, suddenly, to build up a magnetic field which is indicated by field lines 25 and which results in the clamping ring 17 being radially upset. The crimping force is indicated by arrows 21. In this case, too, the sleeve which is positioned inside the clamping ring and the component to which the sleeve has to be fixed are not shown.

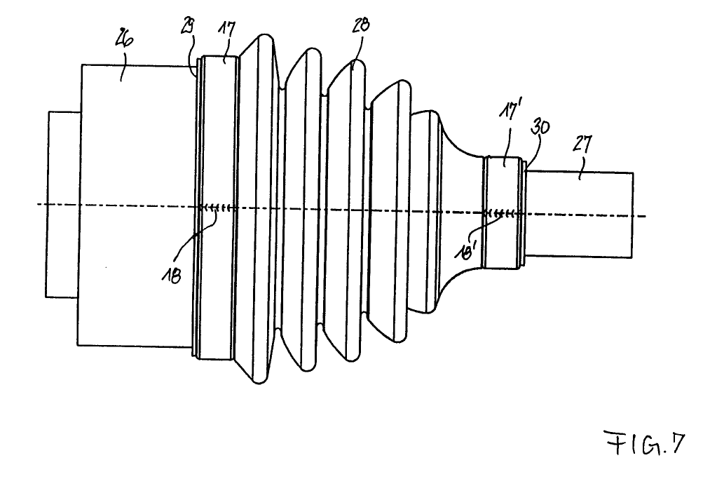

FIG. 7 shows a portion of a driveshaft in the region of a universal joint. An outer joint part 26 of the universal joint forms a first one of the components and an intermediate shaft 27 connected to the inner joint part of the universal joint forms a second one of the components. Thus, the components can articulate with respect to each other, but are shown in the aligned condition. A convoluted boot 28 has been slipped on to both of the components, in each case with a collar region. The collar regions 29, 30 are secured to the outer joint part 26 and to the intermediate shaft 27 under elastic pre-tension by means of clamping rings 17, 17′ which are radially upset after the convoluted boot 28 has been slipped on. The welds 18, 18′ can be identified in FIG. 7.

One method of producing the inventive clamping ring is thus producing a strip portion from the plate metal strip material 12 such that it has strip ends 15, 16 which match and complement one another such that they can be butt joined without overlap. The strip ends 15, 16 can be fashioned as shown in any of FIGS. 2 through 4. The length of the strip portion is chosen such that it is approximately equal to the circumference of the groove in which it will sit on the elastic sleeve. At a minimum, it must be greater than the circumference of the components around which it will affix the elastomer sleeve. Once cut, the strip portion is bent into a round, cylindrical shape with abutting strip ends 15, 16. The strip ends are then welded together to form the clamping ring.

In operation, the finished clamping ring is then slid onto the elastic sleeve in the region in which it will apply a clamping force. The sleeve, together with the clamping ring, is then slid onto one of the components; for example, the outer joint part 26 of a universal joint. Alternatively, the sleeve may be positioned on the component first, with the clamping ring subsequently fitted over the sleeve. Once the clamping band and sleeve are positioned on the component, the clamping band is permanently plastically deformed and the sleeve is elastically deformed by the clamping band. The step of deforming the clamping ring can be carried out by a mechanical annular tool such as shown in FIG. 5, or by angularly arranged magnetic coils as shown in FIG. 6.

While the invention has been described in connection with several embodiments, it should be understood that the invention is not limited to those embodiments. Thus, the invention covers all alternatives, modifications, and equivalents as may be included in the spirit and scope of the appended claims.

What is claimed is:

1. A method of producing metal clamping rings for securing sleeves made of an elastic material on components which are movable relative to one another, comprising the steps of:
producing a strip portion from plate metal, the strip portion comprising strip ends which match and complement one another and which are delimited so as to be undercut-free in the longitudinal direction;
bending the strip portion substantially circular to form a cylindrical ring with abutting strip ends; and
welding the strip ends to form a clamping ring.

2. A method according to claim 1, wherein the step of producing includes cutting a coil of strip material into lengths.

3. A method according to claim 1, wherein the step of producing includes cutting the strip ends to have straight edges which extend at right angles relative to the longitudinal direction of the strip portion.

4. A method according to claim 2, wherein the step of producing includes cutting the strip ends to have straight edges which extend at right angles relative to the longitudinal direction of the strip portion.

5. A method according to claim 1, wherein the step of producing includes cutting the strip ends to have straight edges which extend at an angle relative to the longitudinal direction of the strip portion.

6. A method according to claim 2, wherein the step of producing includes cutting the strip ends to have straight edges which extend at an angle relative to the longitudinal direction of the strip portion.

7. A method according to claim 3, wherein the step of producing includes cutting the strip ends to have beveled straight edges.

8. A method according to claim 4, wherein the step of producing includes cutting the strip ends to have beveled straight edges.

9. A method according to claim 5, wherein the step of producing includes cutting the strip ends to have beveled straight edges.

10. A method according to claim 6, wherein the step of producing includes cutting the strip ends to have beveled straight edges.

11. A method according to claim 1, wherein the step of welding includes at least one of laser welding, plasma welding or electron-beam welding.

12. A method according to claim 3, wherein the step of welding includes at least one of laser welding, plasma welding or electron-beam welding.

13. A method according to claim 5, wherein the step of welding includes at least one of laser welding, plasma welding or electron-beam welding.

14. A method according to claim 1, wherein the step of welding the strip ends together includes at least one of continuously welding, stitch welding or point welding the strip ends.

15. A method according to claim 3, wherein the step of welding the strip ends together includes at least one of continuously welding, stitch welding or point welding the strip ends.

16. A method according to claim 5, wherein the step of welding the strip ends together includes at least one of continuously welding, stitch welding or point welding the strip ends.

17. A method according to claim 11, wherein the step of welding the strip ends together includes at least one of continuously welding, stitch welding or point welding the strip ends.

18. A method of fixing a sleeve made of an elastic material on components which are movable relative to one another, by use of a metal clamping ring, comprising the steps of:
producing a strip portion from plate metal, the strip portion comprising strip ends which match and complement one another and which are delimited so as to be undercut-free in the longitudinal direction;
bending the strip portion substantially circular to form a cylindrical ring with abutting strip ends;
welding the strip ends to form a clamping ring;
positioning the clamping ring on to an elastic sleeve which is positioned on one of said components; and
radially upsetting the clamping ring, with the clamping ring being permanently plastically deformed and with the sleeve being permanently elastically deformed.

19. A method according to claim 18, wherein the step of upsetting takes place mechanically by an annular tool which is divided into several segments.

20. A method according to claim 18, wherein the step of upsetting takes place electro-magnetically by annularly arranged magnetic coils.
